(19) United States
(12) Patent Application Publication
(10) Pub. No.: US 2015/0349590 A1
(43) Pub. Date: Dec. 3, 2015

(54) COIL SLOT FOR CASTELLATED VARIABLE RELUCTANCE MOTOR (CVRM)

(71) Applicant: ELTORQUE AS, Vanvikan (NO)

(72) Inventor: JON EIRIK BRENNVALL, Trondheim (NO)

(73) Assignee: ELTORQUE AS, Vanvikan (NO)

(21) Appl. No.: 14/422,576

(22) PCT Filed: Aug. 12, 2013
(86) PCT No.: PCT/NO2013/050129

§ 371 Date: Feb. 19, 2015

(30) Foreign Application Priority Data
Aug. 20, 2012 (NO) 20120924

(51) Int. Cl. H02K 1/16; H02K 3/28; H02K 3/12

(52) U.S. Cl. CPC H02K 1/165; H02K 3/12; H02K 3/28

(57) ABSTRACT

This publication relates to a coil slot for 6 poled CVRM with 60 degrees angle between the centre of the slots. The slot have a shape so the two planes through centre of the first layer of coil wires wound into two adjacent slots are parallel and that the bottom of the slot has a length so all wires in the first layer touch each other and that the sides walls of the slot has an angle of 60 degrees to the bottom so there is one extra wire in each new wire layer and that the side walls go over to top walls which are perpendicular to the bottom of the slot and that the outer top wall is extended all the way to the centre of the slot where the chamber against the outer top wall for the next coil is smaller than the wire radius and that the inner top wall of two adjacent slots are collinear and that the extension of the inner top walls are outside the inner radius of the teeth and that the outer top walls are collinear.

Castellated Variable Reluctance Motor (CVRM) is described in the literature but only briefly. It is mentioned in the book “Electric machinery” by Fitzgerald et. al. (ISBN 0-07-123010-6) from 2002. Sargos et. al. describes it in his article “Generalized theory of the structures of reluctance step motors” from 1993. However it seems that it has been a curiosity which main application has been accurate stepping. The CVRMs ability to develop torque and power does not seem to have been investigated properly.

The CVRM is easy to confuse it with the popular hybrid stepper motor described in patents EP1280262A2, US 2002/0079750 A1, DE 3536238 A1 and certainly many other patents and articles. Patent DE3536238A1 also show something which may or may not is Castellated Variable Reluctance Motor. It is hard to tell because the inventor is mostly interested in the insulation material, the drawing is of poor quality and the inventor does not describe how the motor is made or function in the text. Since the inventor is speaking of a “2-Phasen-Schrittmotor” I am inclined to say that patent DE3536238A1 describes a hybrid stepper since practical CVRMs always has 3 or more phases.

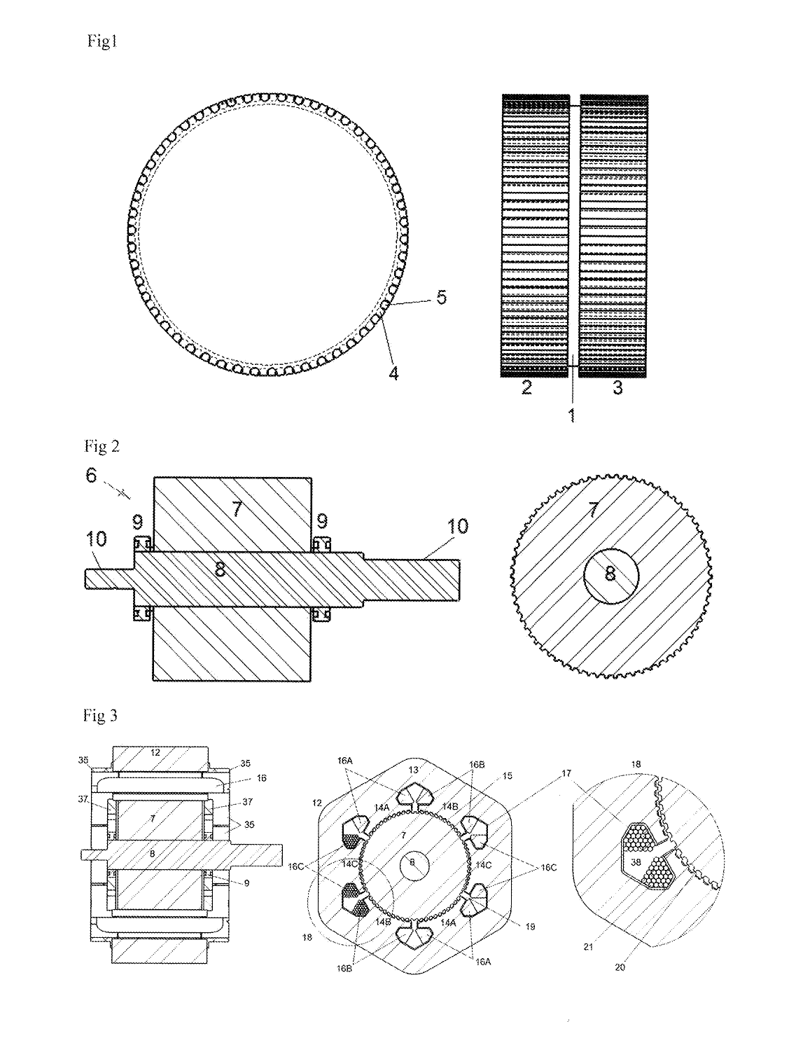

To not mix the Hybrid Stepper Motor with the CVRM it should be noted that the rotor in hybrid stepper motors includes one or more permanent magnets. A figure of a rotor in a hybrid stepper motor is shown in FIG. 1. The rotor consists of two stacks 2,3 of laminated electrical steel with a permanent magnet 1 between. Note how the bottom laminated stack 3 is twisted relative to the upper laminated stack 2 so the teeth 5 of stack 3 is visible between the teeth 4 of stack 2 when seen from above. The teeth in the hybrid stepper motor then become magnetic north poles and south poles and interact with stator in the same way as is the teeth had been replaced with small permanent magnets placed on an iron cylinder. Note that the magnetic flux pattern and operation of a hybrid stepper motor is completely different from the flux pattern and operation of a CVRM, and the motors can therefore not be considered as “related” although there is man physical similarities. This means that all literature which describes hybrid stepper motors is irrelevant for the clams in this patent.

CVRMs are reluctance motors without permanent magnets in rotor where any number of poles and teeth in stator and is possible. Sargos et. al. describes the more common combinations. However the combinations which utilises the area of air gap 20 best is an equal number of poles with an equal number of teeth on each pole. CVRM which shall deliver torque at all angles and a have flux path which utilises the magnetic field both at entry and exit of rotor must have minimum 6 poles and minimum be a 3 phased machine.

The CVRM with 6 poled, 3 phased and a relative large number of teeth on each pole give good torque/weight and torque/price ratio for two reasons. First reason is that the magnetic field strength (B) trough a coil is dependant of number of turns in that coil. This means that four coils with radius r will produce the same magnetic flux as one coil with radius 2r, but the four coils with radius r will require twice as much copper to produce the same torque. Since copper is expensive this influence the price directly. CVRM with 12 poles will for the same reason have twice as much ohmic loss as a CVRM with 6 poles. In addition the coils takes physical space meaning that the coil area in a 12 poled CVRM is less than half size of the coil area in a 6 poled CVRM if the motors have the same dimensions. The torque will therefore be less. The second reason why CVRM produces much torque is that torque of a motor is a function of change in magnetic energy divided on change of rotor angle. More teeth means that the magnetic energy change faster with change in angle, making the CVRM capable of producing considerable more torque then normal reluctance motors. Because the magnetic leakage also increases with number of teeth there are an optimal number of teeth depending on the CVRM's radius. CVRM with high number of teeth requires current with very high current frequency to reach high speed. This limits the maximum speed. The symmetrical CVRM with outer diameter 125 mm, 6 poles, 3 phases, 11 teeth on each pole and a rotor with four more teeth then stator have as result of optimizing shown it selves to be a machine with good torque/weight and torque/price ratio.

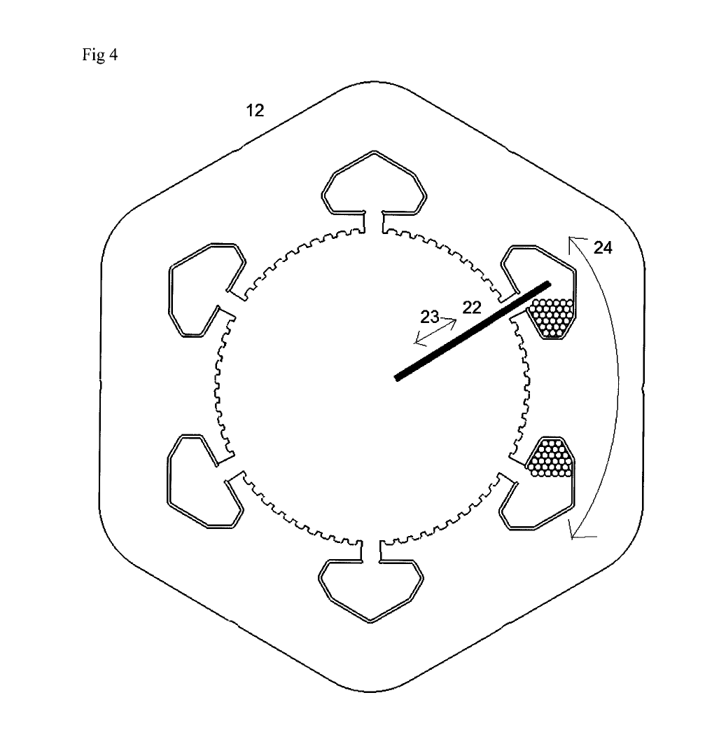

A rotor of a CVRM with 6 poles, 3 phases and 11 teeth on each pole is shown in FIG. 2 and FIG. 3. FIG. 2 show the rotor alone. The rotor 6 consists of laminated electrical steel 7 mounted on a shaft 8 with bearings 9. The shaft has extensions 10 which are used to connect the motor to the load. The laminated steel 7 has on the figure seventy teeth 11. FIG. 3 show the rotor 6 and stator together 12. The stator 12 consists of laminated iron 13, coils 16, and copper wire protection 17. It is necessary to place copper wire protection 17 in the slot 38 to manufacturing the stator without damaging the copper wire in the coils 16 but it would be preferable to make the copper wire protection as thin as possible. The stator iron is shaped so it has poles 14 where each pole has eleven stator teeth 15. Two end plates 37 are inserted into each end of the stator as support for the bearings 9.

The motor's behaviour of operation is that current is sent through coils 16A so the teeth in phase 14A become magnetized. The stator teeth 15 in phase 14A will the aligned with the rotor teeth 11. When the rotor teeth 11 is almost aligned, the current in coils 16B are turned on while the current in phase 16A is turned off and make the rotor rotate further. Turning on and off current in coils in sequence 16A, 16B, 16C and then 16A again will cause the rotor to rotate in one direction. Changing the sequence to 16A, 16C, 16B and then 16A again will cause rotation in the opposite direction. Starting switching at low speed and then increase will work, but is not optimal. Optimal control requires that the rotor position is known either from an encoder, or by estimation from current measurements and a motor model. Unlike permanent magnet motors (including the hybrid stepper motor) it is not necessary to change the current direction in the coils in a reluctance motor, something which simplify the power electronics.

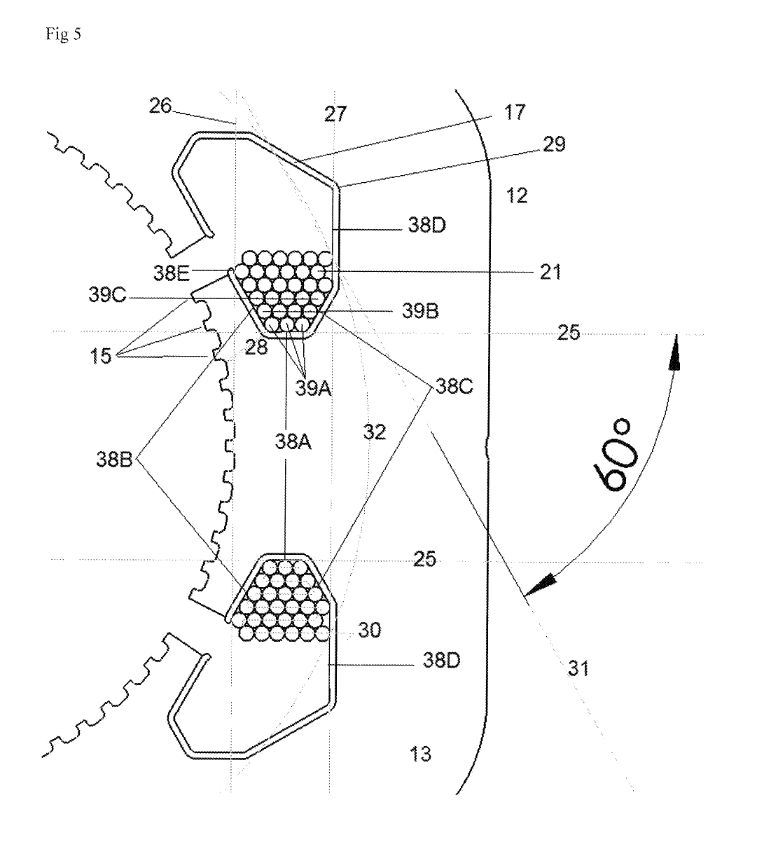

Practical CVRM's suited for mass production has some special requirements compared to other machines, especially if the wires in the coil shall get optimal fill factor as shown in the enlarged part 18 of the cross section in FIG. 3 where individual wires 21 are shown. Because the coils in CVRM's with the design described have high inductance the coils shall be made of relative thick wire. For mass production it must be possible to wind the coils automatically with a needle winder or similar equipment. A needle winder consists of a needle 22 which can be moved in and out as along arrow 23 on FIG. 4. The needle is also moved up and down. In most needle winder designs the stator 12 is mounted on a rotation mechanism which can move stator rotate stator along arrow 24. Patent on needle winders comes in under patent classification HO2K15/085. Patent WO2011031711 and KR20070104978 are examples of such equipment.

A coil for a VRMS must fulfill a few requirements shown in FIG. 5. Line 26 must be outside the inner tip of the stator teeth 15 if it shall be possible to insert rotor 6 into the stator after winding. This is because it is very difficult to curve the coil wire along the radius of the stator on top and bottom of the stator both with manually and automatically winding. The length marked by line 28 must be long enough that magnetic field can be conducted through the iron to the teeth on the edge on the pole. Lines 25 which marks the bottom of the slot 38A should be parallel. If the lines are not parallel the wire will tend to slide against the point where the lines 25 cross and make the winding difficult. The inner and outer slot side wall 38B, 38C must have an angle to the bottom of the slot 38A of 60 degrees so the second coil layer 39B have one wire more than first coil layer 39A and the third coil layer 39C has one more wire then the second coil layer 39B and so on. The inner and outer slot top walls 38E, 38D is perpendicular to the bottom of the slot 38A. The outer slot top wall 38D must be extended to the centre of the slot. The plane through the inner top wall is parallel to line 26, and this line must be outside the cylinder created by the teeth 15 of the stator 12. The corners of the slots can be chamfered with a radius equal to the radius of the coil wire. The corner 29 marks the centre of the slot. This corner 29 should be on the line 27 so all the wires can be placed in the slot correctly. For wire loop 21A and 21B on FIG. 5 it is necessary for the needle to place the wire all the way into corner 29 before the stator is twisted. If the needle place the wire significantly closer to the centre of the stator the wire will place it selves in position 21C. This will give a random wire pattern with very poor fill factor.

With advanced winding machines it is maybe possible to deviate a little from this so corner 29 can be placed closer to arc 32 which marks the outer surface of the wire longest from stator centre. The motor would benefit from this since there will be more iron for conducting magnetic flux behind the coils, but this will be very difficult to archive with automated winding although it is possible to do by manually winding.

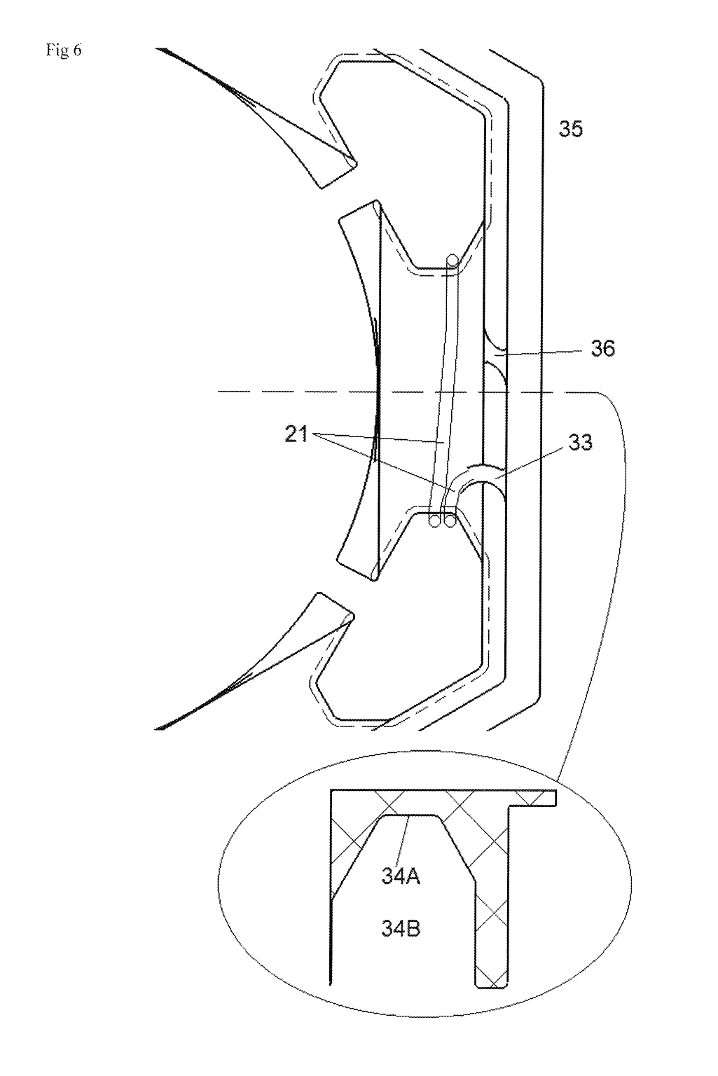

The arrow 30 is showing in which order the wires should be winded. It is not possible to archive this pattern in the entire coil. FIG. 6 show how the wire is led into the coil slot through a deep groove 33. This groove goes all the way to the bottom 34A of the slot 34B in the wire support 35 which keeps the coils 16 in place. Grove 36 is for taking the wire out, but it is not deep because the slot 34B is filled with wire when the wire is taken out. This solution makes sure that the wire crossing in the coils 16 is only at the top of stator, and that the wire pattern shown in FIG. 5 will be correct for the rest of the coil. Because of the crossing the coil will be ca 16% (1/cos(60)-1) thicker on the top, but the rest of the coil, including the coil slots and the bottom will have a fill factor (excluding the wire protection 17 and wire insulation) close to π/(2\sqrt{3}) which is optimal for round wire.

1. Coil slot for 6 poled CVRM with 60 degrees angle between the centre of the slots, characterized by that the slot has a shape so the two planes through centre of the first layer of coil wires wound into two adjacent slots are parallel and that the bottom of the slot has a length so all wires in the first layer touch each other and that the sides walls of the slot has an angle of 60 degrees to the bottom so there is one extra wire in each new wire layer and that the side walls go over to top walls which are perpendicular to the bottom of the slot and that the outer top wall is extended all the way to the centre of the slot where the chamber against the outer top wall for the next coil is smaller than the wire radius and that the inner top wall of two adjacent slots are collinear and that the extension of the inner top walls are outside the inner radius of the teeth and that the outer top walls are collinear.

2. Coil slot for 6 poled CVRM with 60 degrees angle between the centre of the slots according to claim 1, characterized by that the centre corner of the slot is given a chamfer larger than the wire radius to take advantage of new advanced winding machines.

3. Coil slot for 6 poled CVRM with 60 degrees angle between the centre of the slots according to claim 1, characterized by that the wire support is given two thin slots for taking the wire in and out of the slot where the thin slot for taking the wire into the coil slot goes all the way down to the bottom of the slot.
